(19) United States
(12) Patent Application Publication
(10) Pub. No.: US 2012/0249385 A1
(43) Pub. Date: Oct. 4, 2012

(54) Ultra-Wideband Conformal Low-Profile Four-Arm Unidirectional Traveling-Wave Antenna With A Simple Feed

(75) Inventor: Johnson J.H. Wang, Marietta, GA (US)

(73) Assignee: WANG ELECTRO-OPTO CORPORATION, Marietta, GA (US)

(21) Appl. No.: 13/398,477

(22) Filed: Feb. 16, 2012

Related U.S. Application Data
(60) Provisional application No. 61/469,409, filed on Mar. 30, 2011.

(51) Int. Cl. H01Q 11/02; H01Q 11/10

(52) U.S. Cl. 343/731

(57) ABSTRACT

The invention is a class of planar unidirectional traveling-wave (TW) antenna comprising a planar four-arm TW radiator ensemble, such as a 4-arm spiral, which is fed medially with a twin-lead feed connected with only a pair of opposite arms of the TW radiator, with the other two arms parasitically excited. The use of a mode suppressor enhances the purity of single-mode TW propagation and radiation. The twin-lead feed is connected with the balanced side of a balun, and is impedance matched with the TW radiator on one side and the balun on the other side. This simple feed structure using a single balun is generally smaller and much simpler, and thus much less costly than the conventional feed for a 4-arm spiral, which is a complex one-to-four power divider that contains hybrids, power dividers, couplers, matrices, etc.

### CROSS-REFERENCE TO RELATED APPLICATION

This application claims priority to copending U.S. provisional application entitled, “Ultra-Wide Conformal Low-Profile Four-Arm Unidirectional Traveling-Wave Antenna with a Simple Feed,” having Ser. No. 61/469,409, filed Mar. 30, 2011, which is entirely incorporated herein by reference.

### TECHNICAL FIELD

The present invention is generally related to radio-frequency antennas and, more particularly, ultra-wideband low-profile multi-arm unidirectional traveling-wave (TW) antennas for conformal mounting on platforms.

### BACKGROUND

The traveling-wave (TW) antenna is a class of ultra-wideband platform-compatible low-profile antennas, including the spiral-mode microstrip (SMM) antennas and miniaturized slow-wave (SW) antenna, among others. The SMM antenna was discussed in publications (Wang, J. J. H. and V. K. Tripp, “Design of Multioctave Spiral-Mode Microstrip Antennas,” IEEE Trans. Ant. Prop., March 1991; and Wang, J. J. H., “The Spiral as a Traveling Wave Structure for Broadband Antenna Applications,” Electromagnetics, 20-40, July-August 2000) and U.S. patents (U.S. Pat. No. 5,313,216, issued in 1994; U.S. Pat. No. 5,453,752, issued in 1995; U.S. Pat. No. 5,589,842, issued in 1996; U.S. Pat. No. 5,621,422, issued in 1997; U.S. Pat. No. 7,545,335 B1, issued in 2009) which are incorporated herein by reference. The SW antenna is a subset of the TW antenna with its size miniaturized by the SW technique (U.S. Pat. No. 6,137,453 issued in 2000, which is incorporated herein by reference). These thin planar antennas generally consist of an ultra-wideband planar radiator in the form of a multi-arm spiral, sinuous structure, or other frequency-independent geometries, among which the most widely used is the two-arm spiral antenna, having a unidirectional radiation pattern.

The unidirectional radiation pattern is due to mode-1 of TW modes; presence of other TW modes, 0, 2, 3, 4, etc. would distort the radiation pattern. Because of the lack of full symmetry, the commonly used two-arm unidirectional spiral radiator cannot achieve a high degree of mode purity, thus is limited in radiation pattern performance. For applications requiring high-quality radiation patterns, such as the GNSS (Global Navigation Satellite System) receive antenna or elements in planar phased arrays, a four-arm spiral radiator in the SMM antenna was more desirable (e.g., Wang and Triplett, “High-Performance Universal GNSS Antenna Based on GNSS Antenna Technology,” IEEE 2007 International Symposium on Microwave, Antenna, Propagation and EMC Technologies for Wireless Communications, Hangzhou, China, 14-17 Aug. 2007 which is incorporated herein by reference).

Unfortunately, to realize the potential of the four-arm SMM antennas, or the cavity-loaded spiral antenna, a high-quality four-terminal feed is needed to provide equal amplitude and relative phases of 0°, 90°, 180°, 270°, respectively. Such a complex feed, which uses a number of hybrids, power dividers, couplers, matrices, etc. leads to enormous escalation in cost and reduction in gain/efficiency as compared with the two-arm version. Additionally, the complexity and size of such a four-arm feed pose a serious difficulty in its physical implementation in GNSS and array antennas. Disclosed are various embodiments for a method in which these 4-arm unidirectional TW antennas are fed with a mechanism using a single balun that is generally smaller, much simpler, and thus much less costly, feed. The geometric symmetry of the new approach can also lead to a more accurate feed and thus improve the high performance of the four-arm version further above the two-arm version, at a low cost.

### BRIEF DESCRIPTION OF THE DRAWINGS

FIG. 1A depicts, in top view, an ultra-wideband low-profile 4-arm unidirectional traveling-wave antenna fed by a simple balun with a mode suppressor.

FIG. 1B depicts, in side view, the ultra-wideband low-profile 4-arm unidirectional traveling-wave antenna of FIG. 1A.

FIG. 2A shows top view of the feed region for the ultra-wideband low-profile 4-arm traveling-wave antenna in FIG. 1A.

FIG. 2B shows side view of the feed region for the ultra-wideband low-profile 4-arm traveling-wave antenna in FIG. 1A.

FIG. 2C shows A-A′ cross-sectional view of the feed region for the ultra-wideband low-profile 4-arm traveling-wave antenna in FIG. 2A.

FIG. 2D shows B-B′ cross-sectional view of the feed region for the ultra-wideband low-profile 4-arm traveling-wave antenna in FIG. 2B.

FIG. 3A depicts a planar four-arm sinuous TW radiator.

FIG. 3B depicts a planar four-arm log-periodic TW radiator.

FIG. 4 shows measured VSWR over 1-10 GHz for the unidirectional traveling-wave antenna in FIG. 1A and FIG. 1B.

FIG. 5 shows typical measured elevation radiation patterns in two orthogonal linear polarizations over 1-10 GHz for the unidirectional traveling-wave antenna in FIG. 1A and FIG. 1B.

FIG. 6 shows measured antenna gain in dBi over 1-10 GHz for the unidirectional traveling-wave antenna in FIG. 1A and FIG. 1B.

### DETAILED DESCRIPTION OF THE INVENTION DISCLOSURE

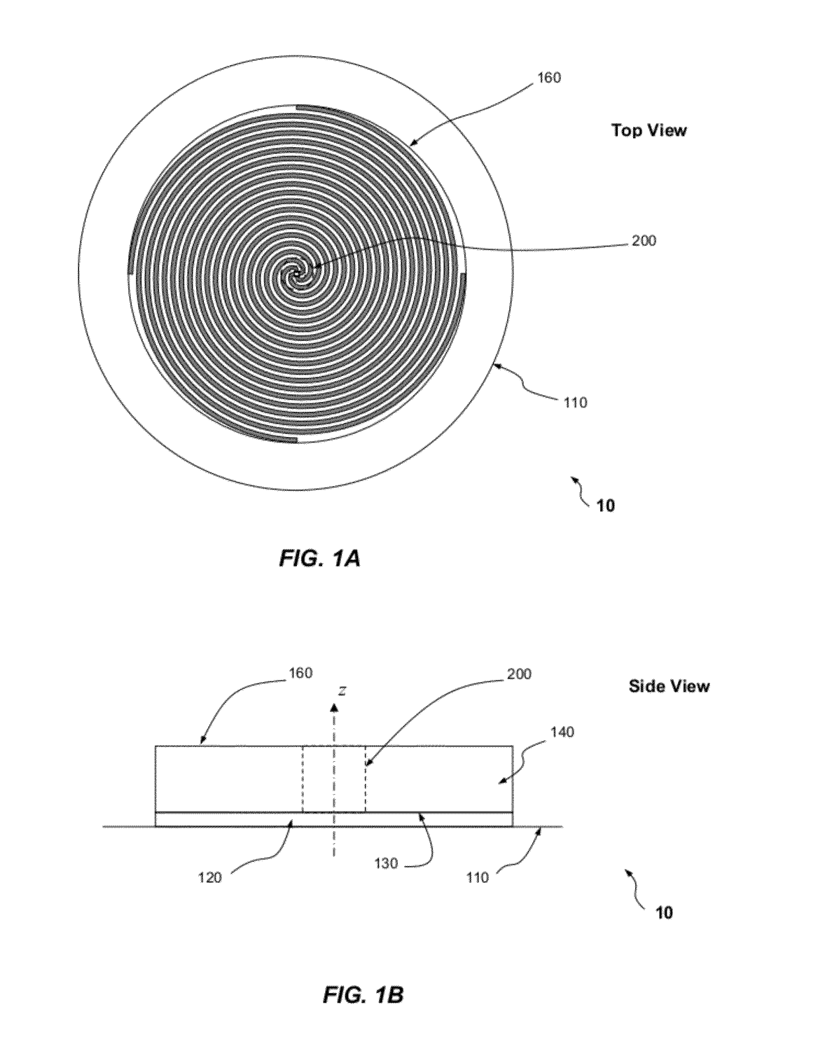

FIGS. 1A and 1B depict the top and side views, respectively, of an ultra-wideband low-profile mode-1 4-arm traveling-wave (TW) antenna 10, which is of the shape of a pillbox, preferably circular but can be of other polygonal cylindrical form symmetrical about its center axis z. The antenna 10 is comprised of a planar conducting plane 110, a feed network 120, a planar conducting plane 130, a TW structure 140, and a planar TW radiator ensemble 160, stacked, one on top of the other, sequentially, as well as a feed ensemble 200. The thickness of the antenna 10 is electrically small, generally less than 0.1 λ_{L}, where λ_{L} denotes the free-space wavelength at the lowest frequency of operation. The diameters of the planar TW radiator ensemble 160, the TW structure 140, and the feed network 120 are generally the same and preferably less than 0.4 λ_{L}. The diameter of the planar conducting plane 110 must be at least as large as that of the TW structure 140.

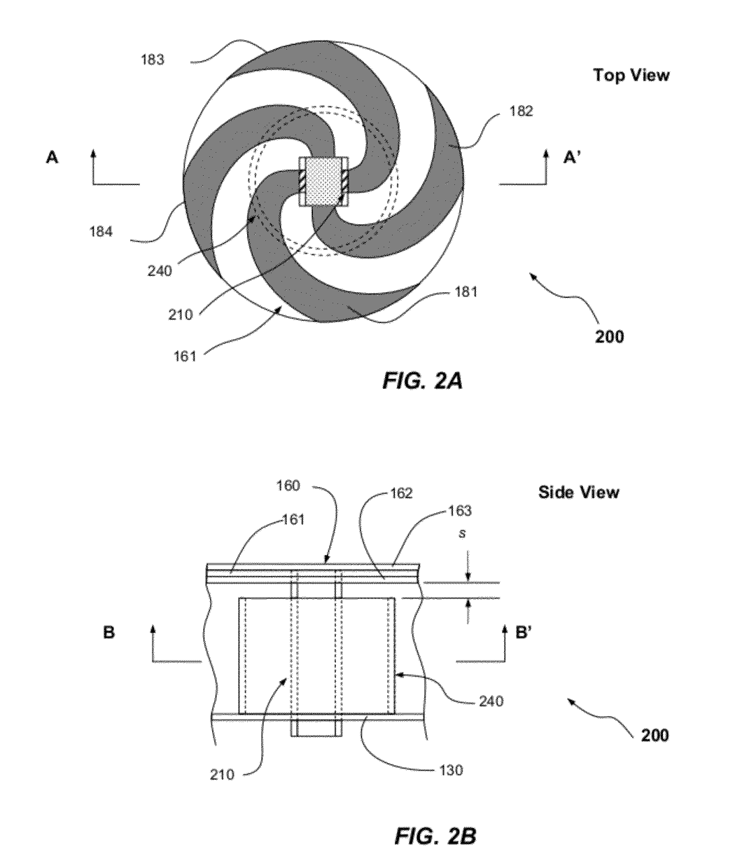

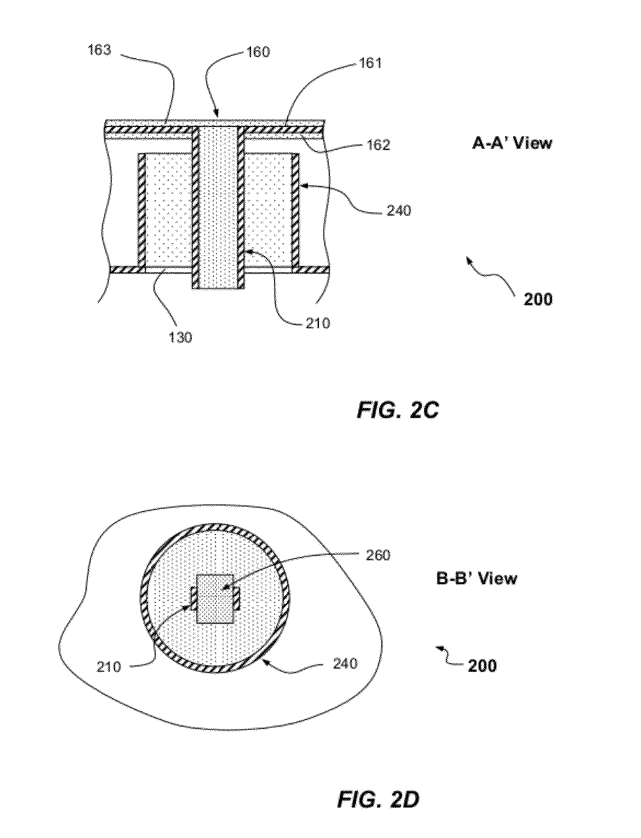

The planar TW radiator ensemble 160 is excited by feed ensemble 200, which is connected with a simple balun contained in the feed network 120. Note that, for the convenience of illustrating the details of the configuration, we define a small region in antenna 10 that contains the feed ensemble 200 in the center, with their components designated numerically in 200s. The periphery of feed ensemble 200 is somewhat arbitrary, defined for the convenience of illustration, not as a structurally exclusive region. In fact, the drawings in FIGS. 2A, 2B, 2C, and 2D showing the details of the feed ensemble 200 exhibit some structural overlaps with the rest of antenna 10. Practically, the regions inside and outside feed ensemble 200 are expected to be well integrated in manufacturing.

The TW antenna 10 is to be conformally mounted on the surface of a platform, which is generally curvilinear. As a practical matter, the antenna is often placed on a relatively flat area on the platform, and does not have to perfectly conform to the platform surface since the TW antenna has its own conducting ground surface. In practice, the conducting ground surface is generally chosen to be planar or part of a canonical shape, such as a cylinder, sphere, or cone that is easy and inexpensive to fabricate. In any case conducting surfaces 110 and 130, as well as TW structure 140 and TW radiator ensemble 160, share the same canonical shape and are all parallel to one another and symmetrical about the vertical center axis z.

FIG. 2A shows a top view of the TW radiator ensemble 160 in the feed region. As shown in the side view and cross-sectional A-A′ view in FIGS. 2B and 2C, respectively, the TW radiator ensemble 160 consists of three thin layers: the TW radiator 161 in the center layer, the dielectric superstrate 163 and the dielectric substrate 162. Note that the drawings in FIGS. 1A and 2A show embodiments in which the thickness of superstrate 163 vanishes and thus the TW radiator 161, a four-arm Archimedean spiral in this case, is visible. Note that the diameter of feed ensemble 200 is arbitrarily selected for the convenience of illustration, and there is no structural discontinuity at the circular boundary.

In prior art, the four terminals of the spiral in mode-1 operation, designated as arms 181, 182, 183, and 184, respectively, are fed with excitations of equal amplitude and relative phases of, say, 0°, 90°, 180°, 270°, respectively and consistent with the sense of the polarization of the spiral. In this invention, one pair of opposite terminals 181 and 183 is excited with equal amplitude and relative phases of 0° and 180°, respectively, and the other pair of opposite terminals 182 and 184 is excited parasitically, by the feed ensemble 200, as shown in A-A′ cross-sectional view in FIG. 2A. To ensure that the parasitic excitation of terminals 182 and 184, without direct contact with the feed line, is proper, we employ a feed ensemble 200, which comprises a twin-lead feed 210 and a mode suppressor 240.

The twin-lead feed 210 has an impedance around 100 ohms, and is to be fine-tuned to match the impedance of the TW radiator ensemble 160 in the environment of TW structure 140 and mode suppressor 240 over the ultra-wide frequency band of operation. As shown in FIGS. 1B, 2B and 2C, the twin-lead feed 210 extends beyond the conducting ground plane 130 and then connects the two output terminals on the balanced side of a balun positioned in the feed network 120, which is generally a stripline or microstrip printed circuit board enclosed by conducting ground planes 110 and 130 and side conducting walls. A balun is a device that connects an unbalanced transmission line on one side to a balanced transmission line on the other side, and also performs needed impedance matching (transformation) between the two sides. In the present embodiment, the balanced side of the balun is connected to the balanced twin-lead transmission line, and the unbalanced side of the balun is connected to a matching output circuit which leads to an unbalanced coaxial connector at the end of the feed network for connection with an external transmitter/receiver.

The mode suppressor 240 is a circular conducting tube having a small diameter, generally less than about 0.01 λ_{L}, to ensure smooth transition of TW propagation from twin-lead feed 210 and the TW radiator ensemble 160 (FIGS. 1B, 2B and 2C). The top of mode suppressor 240 is spaced at a distance S below the TW radiator ensemble 160 and its bottom joining the conducting ground plane 130. The spacing S is small, less than about 0.01 λ_{L}, and is a tradeoff between smooth launching of mode-1 spiral mode in the TW radiator ensemble 160 and the suppression of higher-order modes in the wave propagation between the TW radiator ensemble 160 and the conducting ground plane 130. FIG. 2B further reveals a B-B′ cross-sectional view of the feed ensemble 200 showing the twin-lead feed 210 and the mode suppressor 240 in the form of a conducting cylindrical tube.

As can be seen in FIG. 2D, the twin-lead feed 210 can be fabricated on a double-sided printed circuit board of a low-loss dielectric substrate 260. Between the twin-lead feed 210 and the mode suppressor 240 is filled, in part or in whole, another low-loss dielectric which may or may not be the same as that of the printed circuit board of the twin-lead feed 210. The feed ensemble 200 can be mass produced by planar printed-circuit-board (PCB) fabrication techniques, in which case the twin-lead feed 210 can start with two circular via holes, which are then metal-plated for integration with the TW radiator 161 (FIGS. 2B and 2C) and balun in the feed network 120.

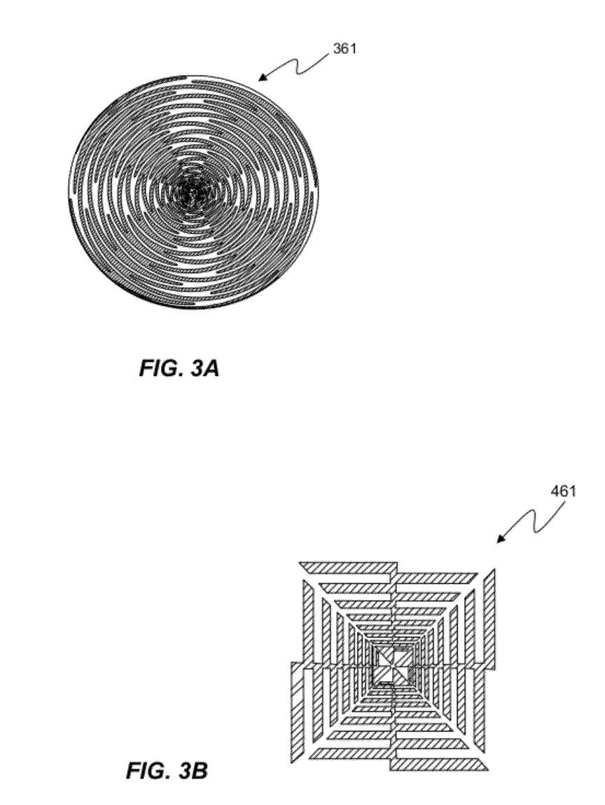

The TW radiator 161, which is a four-arm Archimedean spiral as shown in FIG. 1A, is in general a planar multi-arm frequency-independent structure, most of which are of self-complementary geometry. For example, FIG. 3A depicts a planar four-arm sinuous TW radiator 361, and FIG. 3B depicts a planar four-arm log-periodic TW radiator 461. The spiral type radiator has inherently circularly polarization (CP) with a sense of right-hand CP (RHCP) or left-hand CP (LHCP) determined by the spiral windings being counterclockwise or clockwise for the convention of time-harmonic fields chosen—either exp(jωt) or exp(−jωt).

The sense of the circular polarization of the planar radiators in FIG. 3 is rooted not only in the radiator per se but also in the way the four arms are fed, in the sequence of (0°, 90°, 180°, 270°) or (0°, −90°, −180°, −270°). When a non-spiral is employed as TW radiator 161 (FIGS. 3B and 3C) and fed with the present simple feed, it will radiate in linear polarization, which results from the combination of the RHCP and LHCP, in equal phase and amplitude, inherent in the radiator.

The TW structure 140 can be of a slow-wave (SW) type. The use of an SW structure can lead to reduction of phase velocity characterized by a slow-wave factor (SWF). The SWF is defined as the ratio of the phase velocity Vₛ of the TW to the speed of light c, given by the relationship

SWF=c/Vₛ=λₒ/λₛ (1)

where c is the speed of light, λₒ is the wavelength in free space, and λₛ is the wavelength of the slow-wave, at the operating frequency fₒ. Note that the operating frequency remains the same both in free space and in the slow-wave antenna. The SWF indicates how much the TW antenna is reduced in a relevant linear dimension. For example, an SW antenna with an SWF of 2 means its linear dimension in the plane of SW propagation is reduced to ½ of that of a conventional TW antenna. Note that, for size reduction, it is much more effective to reduce the diameter, rather than the height, since the antenna size is proportional to the square of antenna diameter, but only linearly to the antenna height. Note also that in this disclosure, whenever TW is mentioned, the case of SW is generally included. Many variations and modifications may be made to the above-described embodiments of the invention without departing substantially from the spirit and principles of the invention. All such modifications and variations are intended to be included herein within the scope of the present invention.

### Experimental Verification

Experimental verification of the principles of the invention has been carried out satisfactorily. Several breadboard models were designed, fabricated, and tested. Some measured data on one model is displayed here to demonstrate that the principles of this invention are valid, and that the imperfections in the performance are primarily due to the deficiencies of the balun employed.

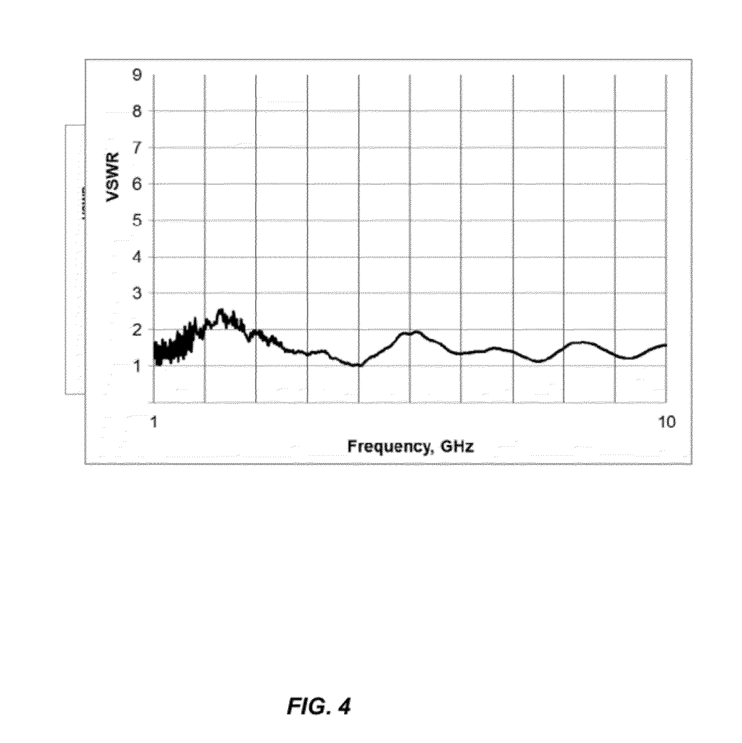

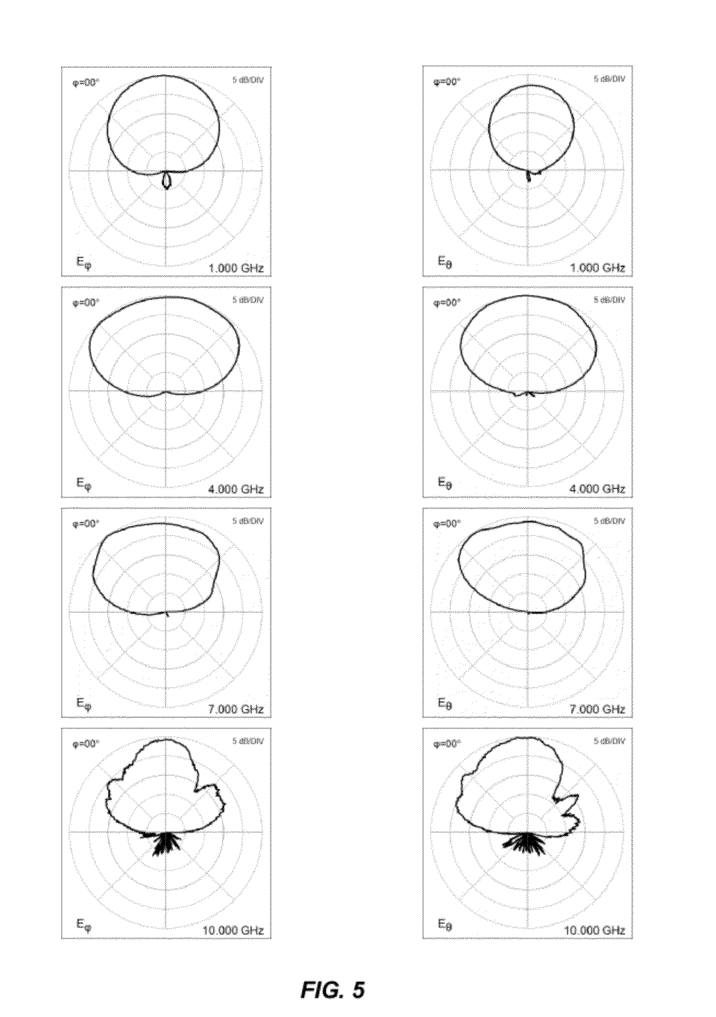

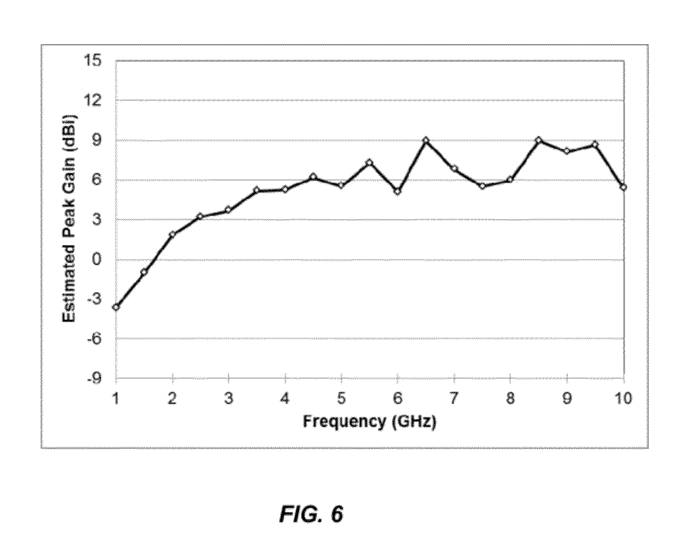

FIG. 4 shows measured VSWR over 1-10 GHz for a breadboard model of the unidirectional traveling-wave antenna in FIG. 1 using a four-arm Archimedean spiral radiator. FIG. 5 shows typical measured elevation radiation patterns in two orthogonal linear polarizations (E_{θ} and E_{φ}) over 1-10 GHz for this antenna. FIG. 6 shows estimated antenna gain in dBi (primarily CP and based on combining measured gain in dBiL and axial ratio for two orthogonal linear polarizations) for this antenna over 1-10 GHz. These data are fairly good for a crude breadboard. Separate tests on the balun alone revealed that amplitude and phase errors in the balun (which is outside the scope of the present invention) are primarily the cause of the imperfections at certain frequencies in the feed output and, consequently, the exhibited performance of the antenna. Later models focused on narrower bandwidths, such as GNSS, for which the component and fabrication tolerances can be more easily met, exhibited greatly improved performance.

1. A unidirectional traveling-wave (TW) antenna comprising:
a vertically stacked structure comprising a conducting ground plane, a feed network, a TW structure, and a planar four-arm TW radiator ensemble, wherein the vertically stacked structure further comprises a feed ensemble in the center;
the feed network comprising a single balun and a matching output circuit, wherein the balanced side of the single balun is connected to a twin-lead feed line in the feed ensemble;
the feed ensemble comprising a twin-lead transmission line and a mode suppressor, wherein the twin-lead transmission line connects a first pair of opposite arms in the medial portion of the four-arm TW radiator ensemble, and a second pair of opposite arms of the TW radiator being parasitically excited; wherein the mode suppressor facilitates TW propagation from the twin-lead transmission line to the planar TW radiator;
the unidirectional TW antenna having a thickness, the thickness being less than 0.1 λ_{L}, wherein λ_{L} denotes the free-space wavelength at the lowest frequency of operation; and
wherein the TW structure, the planar TW radiator, the feed ensemble and the TW antenna are symmetrical about the center axis of the antenna.

2. The unidirectional TW antenna as claimed in claim 1, wherein the planar TW radiator is a four-arm Archimedean spiral.

3. The unidirectional TW antenna as claimed in claim 1, wherein the planar TW radiator is a four-arm sinuous antenna.

4. The unidirectional TW antenna as claimed in claim 1, wherein the planar TW radiator is a four-arm log-periodic spiral.

5. The unidirectional TW antenna as claimed in claim 1, wherein the planar TW radiator is a four-arm equiangular spiral.

6. The unidirectional TW antenna as claimed in claim 1, wherein the planar TW radiator is a planar multi-arm frequency-independent structure.

7. The unidirectional TW antenna as claimed in claim 1, wherein the conducting ground surfaces, the TW structure and the TW radiator ensemble are parallel relative to each other.

8. The unidirectional TW antenna as claimed in claim 1, wherein the conducting ground surfaces, the TW structure, and the TW radiator ensemble are of a canonical shape, the canonical shape comprising: a plane, a cylinder, a sphere, and a cone.

9. The unidirectional TW antenna as claimed in claim 1, wherein the TW structure is a slow-wave structure.

10. The unidirectional TW antenna as claimed in claim 9, wherein the TW antenna having a diameter less than 0.4 λ_{L}/SWF, wherein λ_{L} is free-space wavelength at the lowest frequency of operation and SWF is a Slow Wave Factor.
